(19) United States
(12) Patent Application Publication
(10) Pub. No.: US 2003/0196195 A1
(43) Pub. Date: Oct. 16, 2003

(54) Parsing technique to respect textual language syntax and dialects dynamically

(75) Inventor: Harm Sluiman, Scarborough (CA)

Correspondence Address: David A. Mims, Jr., IBM Corporation, Intellectual Property Law Department, 11400 Burnet Road, Austin, TX, 78758, US

(73) Assignee: International Business Machines Corporation, Armonk, NY (US)

(21) Appl. No.: 10/285,990

(22) Filed: Oct. 31, 2002

(30) Foreign Application Priority Data
Apr. 15, 2002 (CA) 2,381,744

(51) Int. Cl. G06F 9/45

(52) U.S. Cl. 717/143

(57) ABSTRACT

This invention relates to parsing program statements. A parser in accordance with this invention dynamically associates an object with a token in a program statement and executes the object when the token is being processed. The objects collectively embody the grammar of the domain for the program statement. Particularly, an aspect of the invention is a computer readable medium containing computer executable instructions for parsing program statements which when executed by a processor, cause the processor to instantiate a root object having a list of all permissible initial tokens for a program statement and, where an initial token in the program statement is represented in the list, instantiate a subsequent object having a list of all permissible subsequent tokens which may follow the initial token.

### BACKGROUND OF THE INVENTION

This invention relates to parsing program statements.

A user often interfaces with a computing device through a program containing a collection of user instructions in the form of program statements. In almost all cases, program statements are parsed before they are actually executed. In this regard, compilers generally include a parser.

It is often desirable for a parser to support multiple domains. For instance, different developers or vendors of a given computing product, such as a database or a text editor, may implement the product with different dialects of a programming language or even completely different languages; further, the product and its related programming languages are continuously developed, modified, and improved, resulting in different versions of the programming languages. Consequently, there is a need for a software tool that supports these multiple versions from multiple vendors.

Traditionally, parsers are domain specific—each parser works with only one specific version of a programming language from a specific vendor. Syntactic rules are hard coded and statically stored in memory. To change a rule, the parser has to be re-coded, re-compiled, re-linked and reloaded.

Some more recent parsers can be dynamically configured to support multiple domains. One such parser is described in U.S. Pat. No. 5,687,378 to Mulchandani et al. (“Mulchandani”). Mulchandani provides a dynamically reconfigurable parser for syntax validity checking. The reconfiguration is accomplished by reading into memory parse control records at runtime and inserting them into corresponding parse table entries in a parse table resident in memory. Each parse table entry corresponds to a single command of the programming language and includes an ordered series of allowable parse states for that command. Essentially, each parse table entry represents a parse rule for the corresponding command. A tokenized input text string is evaluated pursuant to the allowable parse states in the parse table entries to determine whether the text string has a valid syntax.

Although parsers such as those provided in Mulchandani make it possible to switch between domains at runtime quickly by, essentially, re-loading a new set of syntactic rules, these parsers share with other existing parsers the same deficiencies discussed next.

In conventional parsing techniques, before parsing, the entire set of syntactic rules of the programming language in use is stored in the memory of the computing device running the parser in the form of a syntactic data structure. Common syntactic structures are decision trees and parsing tables, as they are known in the art. For instance, as mentioned, in Mulchandani a parsing table is used. An example of a decision tree is described in Japanese Patent No. 2,266,469 to Michiel et al. (“Michiel”). Michiel provides for checking the syntactical validity of a sentence word by word against a static decision tree. The decision tree has at least one top node, one or more terminal nodes and a number of intermediate nodes, which are mutually coupled by edges that represent the syntactic relation between the two nodes coupled by the edge. Each node has an identifier linked to either a dictionary word or a list of further identifiers to be selected.

A problem with the conventional approach to parsing is that it is not memory efficient. Precious memory space must be allocated for every syntactic rule, whether or not the rule is going to be used during a parsing session. Further, substructures representing common components of different rules are duplicated in memory. The inefficiency worsens as the number of rules increases. The inefficiency multiples when multiple domains are supported as the size of the syntactic data structure multiplies.

Further, conventional parsing tools are difficult and costly to maintain. A data structure representing the entire set of syntactic rules of a domain or domains is often quite complex. A change in one rule, no matter how slight, not only necessitates rebuilding the entire data structure, but also often requires multiple changes in the data structure. For instance, a word may appear in multiple branches of a decision tree. To change a rule related to the word, all branches that contain the word may have to be modified. In addition, re-building an entire syntactic data structure is an error-prone process. it is easy to overlook a necessary change or make an incorrect change. Again, as the number of rules increases, it becomes increasingly more difficult to make and keep track of the changes.

Previously known dynamically-configured parsers also suffer from another problem. They are slower than statically-configured parsers. It takes time to load an entire data structure. It also takes time to unload the data structure when it is no longer needed.

There is a need, therefore, for a parser that is easily and dynamically reconfigurable yet fast, memory efficient, and easy to maintain, which this invention seeks to provide.

### SUMMARY OF INVENTION

A parser in accordance with this invention dynamically associates an object with a token in a program statement and executes the object only when the token is being processed. The parser and the objects collectively embody the grammar of the domain for the program statement. Each object embodies a subset of the grammar related to the associated token and is encapsulated.

In accordance with the purpose of the invention, as embodied and broadly described herein, an aspect of the invention is a computer readable medium containing computer executable instructions for parsing program statements, which when executed by a processor, cause the processor to instantiate a root object having a list of all permissible initial tokens for a program statement and, where an initial token in the program statement is represented in the list, instantiate a subsequent object having a list of all permissible subsequent tokens which may follow the initial token.

Another aspect of the invention is a parser comprising means for instantiating a root object having a list of all permissible initial tokens for a program statement, and means for, where an initial token in the program statement is represented in the list, instantiating a subsequent object having a list of all permissible subsequent tokens which may follow the initial token.

Yet another aspect of the invention is a method for parsing program statements. The method comprises the steps of instantiating a root object having a list of all permissible initial tokens for a program statement and, where an initial token in the program statement is represented in the list, instantiating a subsequent object having a list of all permissible subsequent tokens which may follow the initial token.

Other features and advantages of the invention will become apparent by reviewing the following description in conjunction with the drawings. The objects and advantages of the invention will be realized and attained by means of the elements and combinations particularly pointed out in the appended claims.

### BRIEF DESCRIPTION OF THE DRAWINGS

In the figures, which illustrate example embodiments of the invention,

FIG. 1 is block diagram of a computing system in accordance with an exemplary embodiment of the subject invention,

FIG. 2A shows a sample program statement,

FIG. 2B shows a sample tokenized program statement,

FIG. 3 illustrates how permissible tokens and objects are associated with each other using a Token List and a Class List in accordance with an embodiment of the subject invention,

FIG. 4 is a flow diagram illustrating the operation of an exemplary embodiment of the subject invention, and

FIG. 5 is an object class diagram further illustrating the operation of an embodiment of the subject invention on the sample tokenized program statement shown in FIG. 2B.

### DETAILED DESCRIPTION

Embodiments within the scope of the present invention include computer executable instructions embodied on computer readable medium. It should be understood that such computer readable medium can be any available media accessible by a computing device. By way of example, and not limitation, such computer readable media can comprise random-access memory (RAM), read-only memory (ROM) including programmable-read- only memory (PROM), CD ROM or other optical disk storage, magnetic disk storage, magnetic tape storage, other magnetic storage devices, or any other medium which can embody the desired computer executable instructions and can be accessed by a computing device. Any combination of the above should also be included in the scope of computer readable media.

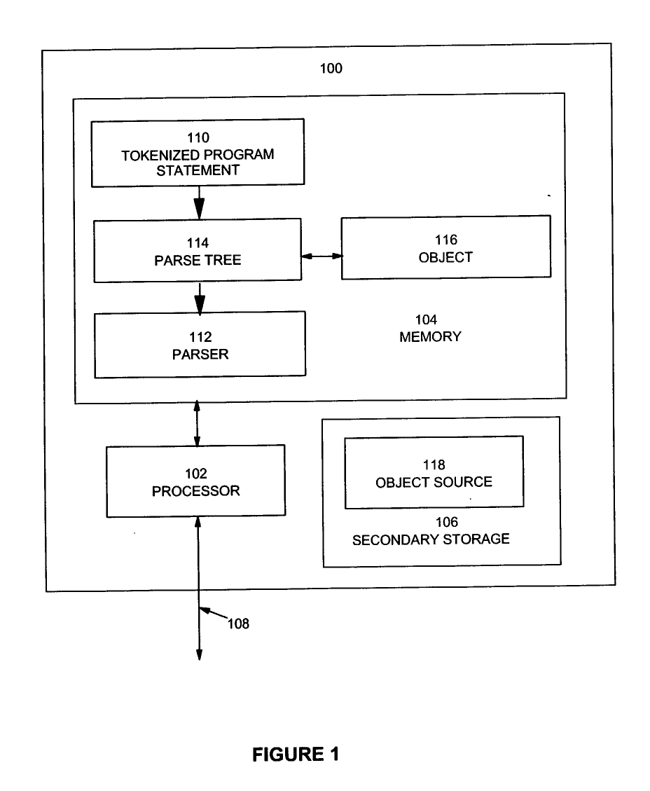

Turning to FIG. 1, a computing system 100 in accordance with an embodiment of the invention comprises a processor 102, memory 104, secondary storage 106, and input/output lines 108. It will be understood by those of ordinary skill in the art that the computing system 100 may also include other, either necessary or optional, components not shown in the figure for the sake of clarity. By way of example, such other components may include elements of a CPU; input devices, such as keyboards, mouse, and microphones; output devices, such as display devices (e.g. monitors), printers, and speakers; network devices and connections, such as modems, telephone lines, network cables, and wireless connections; additional processors; additional memories; additional secondary storage; and the like.

Secondary storage 106 may be any computer readable medium described above. It stores object source 118.

Memory 104 is the main memory for processor 102. It is a computer readable medium, which typically can be randomly accessed by processor 102. Memory 104 includes a tokenized program statement 110, parser 112, parse tree 114, and object 116 associated with the token currently being processed, which is referred to as the “Current Token” hereinafter.

While parser 112 is typically embodied as instructions stored in memory 104, it is executed by processor 102. Parser 112 typically performs two basic functions. First, it checks the syntactical validity of a program statement against a given grammar, and, in this regard, may support grammars of a set of domains. Second, the parser attempts to construct and, if successful, outputs a machine-understandable syntactic data structure, such as a parse tree 114, of the program statement according to the given grammar. However, as will be understood by a person of ordinary skill in the art, parser 112 may be adapted to perform other functions including those typically performed by a lexical analyzer or a semantic analyzer. Particularly, as an example but not limitation, parser 112 may be adapted to tokenize a program statement into a tokenized program statement 110.

A program statement can be any statement comprising a sequence of strings of symbols conforming to a set of lexical and syntactical rules, where all statements conforming to such set of rules form the language of a domain.

A program statement can be received from any number of sources as will be understood by one of ordinary skill in the art. An example source is a program file stored either on a secondary storage 106 or a remote storage connected to computing system 100. Another example source is an application running in either computing system 100 or another computing system in communication with computing system 100. Yet another example source is user input communicated through the input/output lines 108, such as when a user types in a command on a keyboard.

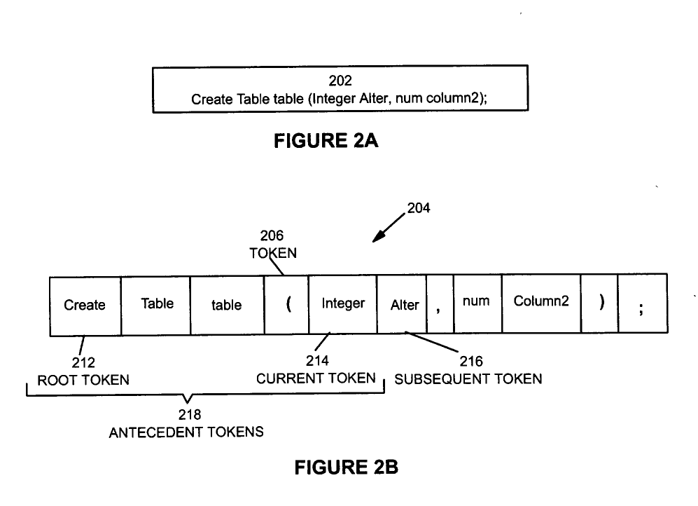

FIG. 2A shows a sample program statement 202 written in the Structured Query Language (SQL) Data Definition Language (DDL), a language commonly used for manipulating database objects.

FIG. 2B shows a sample tokenized program statement 204. In FIG. 2B, each box contains a token 206. Generally, a tokenized program statement 110 is an ordered sequence of tokens 206, where a token 206 is a string of symbols conforming to the lexical rules of the domain. A program statement may be tokenized by parser 112 or otherwise in a manner understood by a person of ordinary skill in the art.

The first token to be processed is the Root Token 212. A Root Token 212 may be the token with which a program statement begins, e.g., “Create” in the sample program statement 202. As mentioned, a Current Token 214 is the token presently being processed. In FIG. 2B, the token “Integer” is indicated as the Current Token 214 for illustration purpose. A Subsequent Token 216 is the token to be processed immediately after the Current Token 214. In the example of FIG. 2B, “Alter” is currently the Subsequent Token 216. As Current Token 214 changes from time to time as processing progresses, so does the Subsequent Token 216. Thus, once “Integer” has been processed, and assuming the parsing proceeds normally without error, the token “Alter” would become the Current Token 214 and the token Comma (“,”) would become the Subsequent Token 216. As is apparent, there may or may not be a Subsequent Token 216. For instance, when the Semicolon (“;”) is the Current Token, there would be no Subsequent Token 216. An antecedent token 218 is any token processed before the subsequent token 216. Of course, there is no antecedent token for the Root Token 212.

Returning to FIG. 1, upon receiving a tokenized program statement 110, parser 112 processes it token by token, in a predefined sequence beginning with the Root Token 212. The processing of a current token 214 depends on a dynamically instantiated object 116 associated with the Current Token 214. As will become more apparent below, object 116 only embodies a subset of the complete grammar for an indicated domain. At any given time, the executing object 116 is dependent upon the tokens in the program statement 110 that have been processed and the token currently being processed. In effect, the executing object 116 is dependent upon all of the previously executed objects and the Current Token 214.

Object Source 118 is the source for the complete collection of objects 116 required to perform parsing. In this description, an object is an object of a class, where “object” and “class” have their ordinary meaning in the object-oriented programming parlance. An object may embody one or more syntactic rules or one or more productions of a rule if there are alternative productions of the rule, such rules and productions being all related to a token which is permissible under a given domain. An object may also be capable of performing operations associated with the permissible token. Collectively, all objects 116 stored in or derivable from Object Source 118 may embody a complete grammar and all associated operations corresponding to the respective rules of the grammar for all of the tokens permissible under each domain supported by the parser 112, as described in more detail below. For a particular object 116, the object source 118 may include the particular object 116 itself, or, alternatively, a source from which the particular object 116 can be machine- generated. For example, an Object Sourcel 18 may include an object, or a class from which the object can be instantiated, or other source code that can be compiled and linked to generate the object.

An object 116 associated with a current token 214 includes a list of all permissible subsequent tokens. The object may also include instructions for associating each of the permissible subsequent tokens with a class and for performing operations related to the current token 214. Such instructions may be implemented as methods in a class from which the object is instantiated. Effectively, the class may implement a grammar subset related to the permissible token, where the grammar subset is part of the grammar of the (indicated) domain. A class associated with a permissible subsequent token is dependent upon the grammar subset related to the permissible subsequent token and any antecedent token. It is possible that the class associated with a permissible subsequent token is the same class associated with the current token. Further, a class may subclass another class therefore inheriting all the attributes and methods of the parent class. As the heritage may be passed on from one object to another object, the object to be associated with a permissible subsequent token not only depends on the currently executing object 116, but may also depend on the sequence of all previously executed objects. Put another way, the object to be associated with a permissible subsequent object depends on the current token and all antecedent tokens.

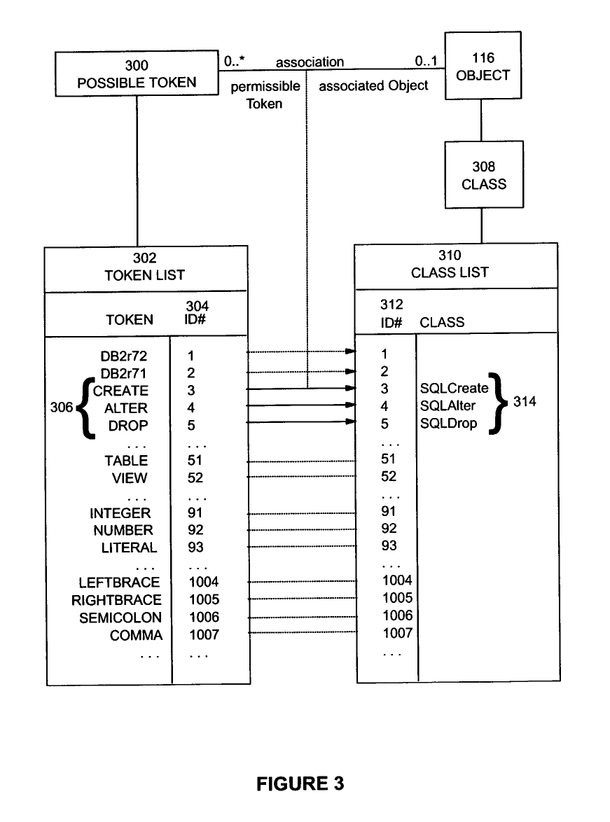

With reference to FIG. 3, in an embodiment of the present invention, permissible tokens 306 and their respective associated objects 116 are associated by way of a token list 302 and a class list 310 maintained by parser 112. Specifically, the token list 302 contains all tokens that are possibly permissible for all supported domains, referred to herein as possible tokens 300. A token 206 may or may not be possibly permissible and hence may or may not be listed in the token list 302. Every possible token 300 is listed and listed only once in the Token List 302. Each possible token 300 has a unique integer ID Number 304. The token list 302 is static and the ID Number 304 of a possible token 300 is fixed, i.e., the token list 302 does not change during the course of parsing one program statement. Ideally, the token list 302 does not change at all. For illustration purposes, the token list 302 in FIG. 3 shows some possible tokens of two SQL DDL domains, DB2 release 7.2 and DB2 release 7.1, supported by an embodiment of the present invention. The exemplary code in JAVA™ programming language in Table I illustrates how the sample token list 302 can be generated.

TABLE 1
Exemplary code for initializing a Token List 302

Package sqlparse;
/*
* sample token list for a SQL DDL domain
*/
public class TokenList
{

public static final int

| // domain indicators | |
|---|---|
| DB2_72 | = 1, |
| DB2_71 | = 2, |
| CREATE | = 3, |
| ALTER | = 4, |
| DROP | = 5, |
| . . . | |
| // parameters | |
| TABLE | = 51, |
| VIEW | = 52, |
| ... | |
| // type keywords | |
| INTEGER | = 91, |
| NUMBER | = 92, |
| LITERAL | = 93, |
| ... | |
| // delimiters | |
| LEFTBRACE | = 1004, |
| RIGHTBRACE | = 1005, |
| SEMICOLON | = 1006, |
| COMMA | = 1007, |
| . . . | |

}

The class list 310 has a static list of class ID numbers 312 which ID numbers correspond to the token ID numbers 304. Each class ID number 312 may be associated with one class 314, but the particular class which is associated with a given class ID number changes, as will become apparent hereinafter. A token ID number associates the corresponding token with whatever class is currently associated with the corresponding class ID number (as indicated by the lines connecting the ID numbers in FIG. 3). In the example shown in FIG. 3, the token ALTER has a token ID number of 4. Thus, since the class SQLAIter is currently associated with class ID number 4, the token ALTER is currently associated with the class SQLAlter. However, unlike tokens, a class 308 may appear multiple times in the class list 310 or may not appear at all. As can be appreciated, a possible token 300 is at most associated with one class 314 at any time but a class 308 may be simultaneously associated with multiple tokens.

The exemplary JAVA™ code in Table II illustrates how part of the sample class list 310 shown in FIG. 3 may be initialized. The class DB2r72 will be instantiated when the indicated domain is domain DB2 release 7.2, which is a dialect of the DB2 domain. The class provides a method for constructing instances of classes SQLCreate, SQLAlter, and SQLDrop, respectively associated with permissible subsequent tokens “create”, “alter”, and “drop”. In this example, all associated objects will be instantiated when the setArray method is called, so the association and instantiation of the objects occur simultaneously. However, as can be appreciated, instantiation may occur later. Further, only the object associated with a Current Token may need to be instantiated. As will be appreciated by those skilled in the art, these objects are class objects (i.e., they follow the singleton pattern).

TABLE II
Exemplary code for initializing Class List 310

Package sqlparse;

Public class DB2r72 extends DB2Domain

{

public DB2r72
{
}
. . .
public void setArray (Object [] classList)

{
try
{

classList[TokenList.CREAT] =

Class.forName(“SQLCreate”).newInstance();

classList[TokenList.ALTER] =

Class.forName(“SQLAlter”).newInstance();

classList[TokenList.DROP] =

Class.forName(“SQLDrop”).newInstance();

...

}

catch(exception exc)
{
\\ throw an exception if there is some kind of an error
}
...

}
}

Once a token is associated with a class, an object of the class can be instantiated and executed when the token is to be processed. For instance, when the token “create” is to be processed, i.e., becomes the Current Token, the processing logic of parser 112 may be as shown in Table III.

TABLE III
Exemplary logic for processing a Current Token 214

Try

{handler = classList[CurrentTokenID];

\\ e.g., CurrentTokenID = TokenList.CREATE = 3
\\ classList[3] = SQLCreate

handler.process(currentToken);

\\ e.g., SQLCreate.process(create)

}
catch(exception)
{
\\ thrown an exception
}

Unlike Token List 302, the Class List 310 is dynamically updated. It may be re-initialized after a Current Token 214 has been processed. Classes in the class list 310 and the ID number(s) 312 associated with a class therefore change during the course of parsing a program statement. As can be appreciated, the association between a token 300 and a class 308 can be broken or can remain intact as the tokens in the program statement are processed. For instance, in processing the sample program statement, the class list 310 may be re-initialized when “create” becomes the Current Token 214. Assuming the permissible subsequent tokens 306 after “create” are “Table” and View”, then ID numbers 51 and 52 will be assigned classes appropriate for handling “table” and “view”, respectively. Meanwhile, ID number 3 of the class list 310 will no longer be associated with SQLCreate but some other class, e.g., class Error which when instantiated instructs parser 112 that token “create” is in fact not permissible at this point. Similarly, ID numbers 4 and 5 may also be associated with class Error. As can be appreciated, associating the token “create” with a non-existent class may achieve the same effect. Further, since a possible token 300 does not have to be associated with a class at all times, at a given time a class ID number 312 might not be associated with any class or it might become unassociated with any class. An unassociated ID number 312 can be used to signal to the parser 112 that the corresponding possible token 300 is not a permissible token 306 at this time.

As can be appreciated, in this embodiment the token list 302 need not be re-initialized during processing because the changes in permissible subsequent tokens 306 can be reflected by re-initializing the class list 310 only. Of course, if the permissible tokens 306 and their associated classes 314 are the same for two consecutive tokens to be processed, class list 310 does not have to be re-initialized after processing the first of the two consecutive tokens.

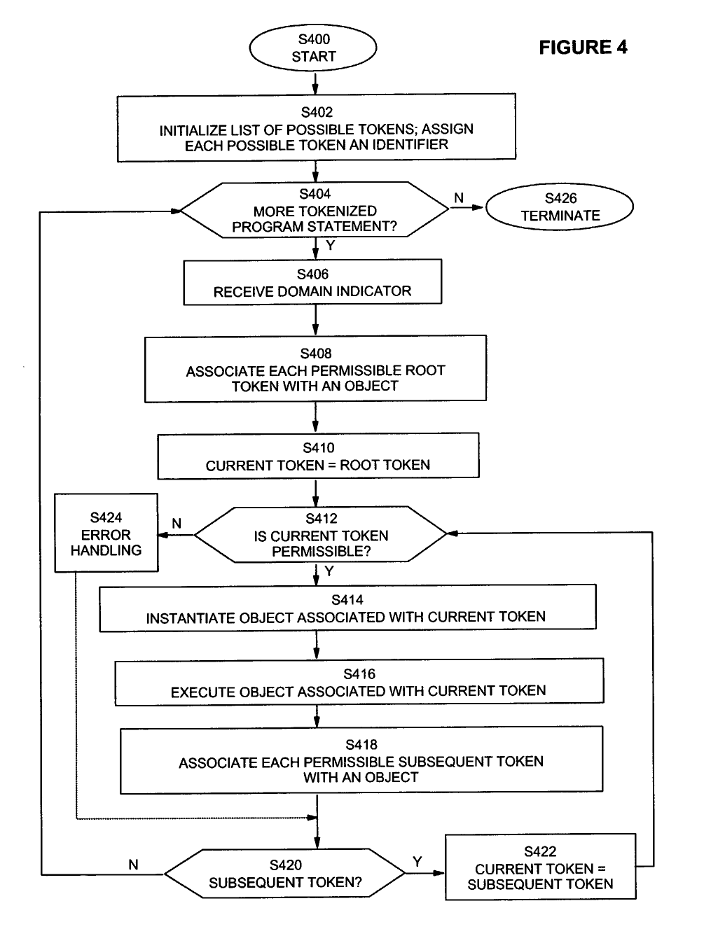

The operation of a parser in accordance with an exemplary embodiment of the present invention is described next with reference to FIG. 4. While the parser described here supports multiple domains, it may be adapted to support only one domain with certain modifications, as will be understood by one skilled in the art.

When the parser 112 is executed (S400), it constructs a Token List 302 and assigns each possible token 300 a token ID number 304 (S402). Processing commences when parser 112 receives a tokenized program statement 110 (S404). As aforementioned, processing starts with the Root Token 212. The Root Token can typically be the first token of a program statement. However, where multiple domains are supported, a domain indicator may be the Root Token. Hence, the parser may receive an indicator of the domain of the program statement (S406), if multiple domains are supported. Next, each permissible Root Token is associated with an object (S408), effectively initializing a list of permissible tokens 306. As mentioned, parser 112 may optionally associate all possible tokens in Token List other than the permissible Root Tokens with an object for processing non-permissible tokens (e.g., an Error object). As the Root Token 212 is the first to be processed it becomes the Current Token 214 first (S410). As can be appreciated, the order of steps from S402 to S408 may vary. For instance, step S402 may take place after steps S404 or S406. Step S404 may be interposed between steps S406 and S408. Where S410 occurs may also vary depending on the actual implementation. Generally, S410 occurs when the Root Token is ascertained. earlier.

The parser 112 then enters into a loop to process each token 206 in the tokenized program statement 110. At the beginning of the loop (S412), parser 112 checks if the Current Token 214 is permissible. If the Current Token is not permissible (“N”), an error has occurred and the error handling (S424) may proceed in an appropriate manner in the circumstances understood by one of ordinary skill in the art. For example, the parser may reject the statement and wait for the next statement (back to S404). Alternatively, the parser 112 may proceed to process the next token (S420) until a permissible token is found. How to handle the error may depend on the currently executing object 116. If the Current Token is permissible, i.e., there is an object associated with the Current Token, the object is instantiated (S414) and executed (S416) or otherwise utilized. It becomes the new executing object 116. Of course, if desirable, the object 116 may be instantiated earlier.

The new executing object 116 may instruct the processor 102 to perform certain operations as required by the rules. It may also instruct the processor to associate each permissible subsequent token with an object, e.g., by re-initializing the class list 310, thus effectively re-initializing the list of permissible tokens 306. Any previous association of a permissible token 306 with an object is thereby updated. As mentioned, the object 116 may also instruct the processor to add the current token to parse tree 114 if it is appropriate to do so. Alternatively, the object may instruct the processor not to add a token to the parse tree 114 immediately, but to wait until certain conditions are met, such as until a certain group of subsequent tokens have been processed.

In any event, after the Current Token 214 has been processed, parser 112 may proceed to process the Subsequent Token 216, if there is any (S420), which then becomes the Current Token (S422). If there is no Subsequent Token, the parser looks for the next tokenized program statement (S404). The parser terminates when there is no tokenized program statement to be parsed (S426).

It should be understood that at any step in FIG. 4, additional functions or operations may be performed. For instance, at any step, an error handling mechanism can be implemented to deal with errors in ways understood by one of ordinary skill in the art. By way of example, but not limitation, one typical error is that the object to be instantiated cannot be found at step S414. The error may occur when either the class from which the object is to be instantiated does not exist or the class cannot otherwise be properly instantiated. The error may occur unexpectedly or by way of design, for instance, for the handling of non- permissible tokens as described earlier.

As alluded to earlier, Step S416 may include substeps to process one or more subsequent tokens in a special way, such as by processing more than one token using one object 116. For example, assume that the Current Token is “table” and the only permissible subsequent token after “table” is a left brace “(”. Further assume that there should always be a right brace “)” after a left brace and anything between the brace pair must follow certain rules. Then, the class associated with “table”, say TableName, may provide special methods or construct instances of classes for processing the brace pair and everything between the brace pair. In this case, it may be more convenient and efficient to process the left brace “(” and the right brace “)” within the method or object without associating them with a separate object. An exemplary logic of such process is shown in Table IV.

TABLE IV
Exemplary logic for processing tokens in a brace pair

associate all permissible tokens with appropriate classes
check for a left brace and if not found throw an exception
until a right brace is found

try
{
handler = classList[currentTokenID]

handler.process(currentToken)

}

catch(exceptions)

{
\\ rethrow exception to caller
}

end until

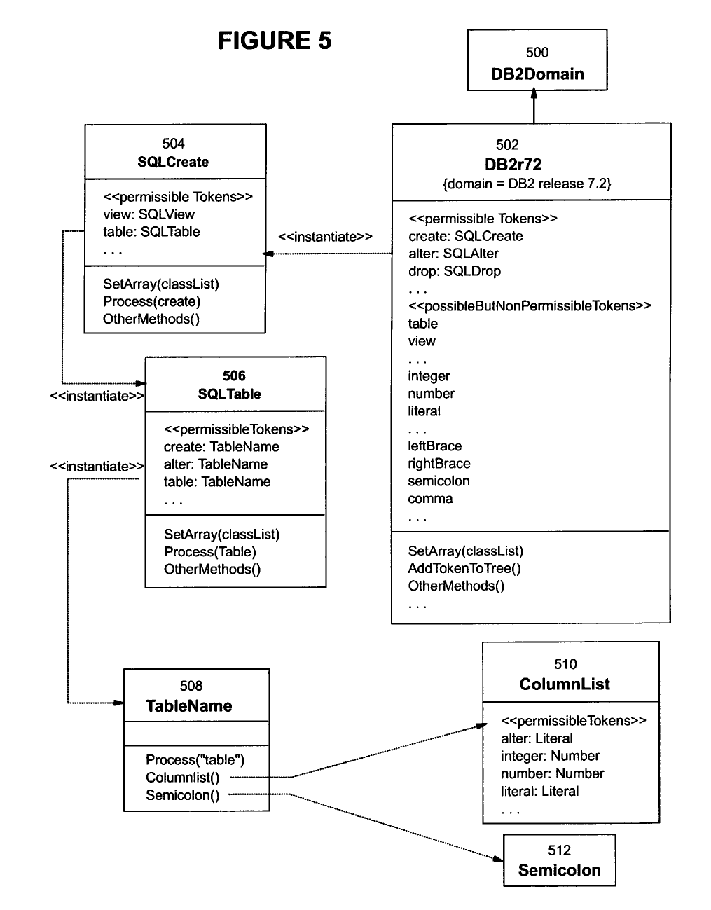

In such cases, the last token in the group of tokens processed (in our example, the right brace) becomes the Current Token after the processing of the group is completed. Using the sample tokenized program statement 204 as an example, the operation and processing sequence of an embodiment of the present invention is further illustrated in FIG. 5. It is assumed that the embodiment supports two domains as described above and the domain indicator DB2r72 has been received.

With reference to FIG. 5 as well as FIG. 3, the parser first initializes a Token List 302 (e.g., using the exemplary code shown in Table I) and associates Root Token DBr72 with the DBr72 class (an exemplary partial code of which is shown in Table II). An object 502 of DBr72 is then instantiated and executed, which associates the permissible Subsequent Tokens “Create”, “Alter” and “Drop” with objects of classes SQLCreate, SQLAlter, and SQLDrop, as explained earlier.

The first token in the tokenized program statement is “Create”. Therefore, an object of SQLCreate (an exemplary partial code of which is shown in Table lll) is instantiated and executed. Object SQLCreate 504 processes the token “create” and associates Permissible Subsequent Tokens “Table” and “View” with objects of classes SQLTable and SQLView respectively.

The next token in the tokenized program statement is “Table”, therefore an object 506 of SQLTable is instantiated and executed. The token “Table” is processed. The only permissible Subsequent Token is a literal, which is the name of the table to be created. Since a literal can be any words or string of symbols except certain delimiters, all permissible tokens of the domain are associated with an object 508 of the TableName class, which handles all tokens as literals as long as they are valid literals. Most tokens in the Token List, which, in other instances, can denote command or keywords, such as “Create”, “Alter”, and particularly “Table”, are all expressly associated with an object 508 of TableName so that if one of them is the Subsequent Token 216, it would not be handled as a command or keyword but as a literal for the name of the table to be created. If certain tokens need to be reserved and cannot be used as table names, these tokens can be associated with an object of a class that handles errors, or they can be disassociated with any class so that if one of such tokens is the Subsequent Token, it would cause the processor to throw an exception.

The next token in the tokenized program statement is “table”. Since “table” is no longer associated with SQLTable but TableName class, an object 508 of TableName is instantiated and executed. The current token “table” is processed accordingly. As mentioned earlier, in certain situations it may be desirable for a class object to handle more than one token and the above recursive process need not be followed rigorously. To demonstrate, the TableName object is so constructed that once a valid literal is processed, it knows that what follows should be pairs of numbers and column names, separated by a comma and enclosed in a pair of braces. It also knows that the token following the right brace must be a terminal symbol, the semicolon “;”. Therefore, as shown in FIG. 5, after handling the table name “table”, the TableName object 508 instructs the processor to call a method ColumnList which instructs the processor how to handle the braces and everything inside (an exemplary logic of which is shown in Table IV), and a method Semicolon which instructs the processor how to handle the token after the right brace “)”. As shown in FIG. 5, the methods of TableName may instantiate other objects associated with subsequent tokens, such as objects ColumnList 510 and Semicolon 512. In ColumnList 510, permissible tokens may be associated with a Literal object or a Number object, which handles literals and numbers respectively, as appropriate.

Once the last token, the Semicolon “;” in this case, is successfully processed, the parser may cause the processor to construct a complete parse tree 114 for the sample program statement. The structure of the parse tree obviously will depend on the grammar of the domain.

As will be understood by those of ordinary skill in the art, within the scope of the present invention numerous modifications to the exemplary embodiments described herein are possible. For instance, an object may comprise data, or procedures for handling data, or both. A subset of a grammar may be implemented with a plurality objects embodying the data and the procedures separately. These objects can then be instantiated separately. In addition, as can be appreciated, some objects may remain resident in memory if it is more advantageous to do so, such as to balance speed and memory efficiency. In this regard, procedure objects may be left resident in memory and only the data objects are dynamically instantiated, or vise versa. Moreover, data embodying a subset of a grammar can be represented in different forms and structures, including data structures such as an entry in a parse table or a branch of a decision tree and the like.

Further, a parser in an embodiment of the subject invention may be either standalone or incorporated into an application suite such as a compiler. Also, although the above description uses examples in the JAVA™ and SQL DDL programming languages for illustrative purposes, the subject invention may be implemented using any programming language conforming to the object-oriented programming principles and may be used in any programming environment. Further, while the description uses flow diagrams and class diagrams to illustrate the processing steps and structures of certain embodiments of the invention, their use should not be construed as limiting the invention's scope.

Further still, association of tokens and objects can be accomplished in any number of ways understood by a person of ordinary skill in the art. For instance, the identification numbers can be other types of identifiers, for example, sequential symbols other than integers. Also, instead of two separate lists, one list containing both possible tokens and associated classes may be used. A further modification is to implement the association without using identifiers, such as simply pairing up a token and an object in a table or a record.

In addition, the Root Token 212 may be a token other than the first token in a program statement or the indicator of a domain. For instance, a Root Token may be the last token in a program statement, a token that matches one of some pre-defined keywords, or a token of a particular type, such as verb, noun, number, and the like. How a Root Token is determined may depend on the parsing technique and the grammar(s) involved. Also, it should be understood that the sequence of processing tokens may or may not follow the order of tokens in the tokenized program statement. For instance, Subsequent Token 216 may be one that immediately precedes a Current Token if the Root Token is the last token in a program statement. How a subsequent token is chosen may depend on the syntactic rules related to the antecedent tokens 218.

A parser included in an embodiment of this invention as described herein can be easily and dynamically modified. As is apparent, a parser in accordance with the present invention operates without reliance on a complete parsing data structure such as a decision tree or a parsing table. It is therefore not necessary to load a complete parsing data structure into memory before processing as is required in previously known parsers. The parser hence can run faster than previously known dynamically-configured parsers. Because the classes are encapsulated yet can subclass each other, and because the objects are dynamically associated and separately instantiated, it is easy to implement modifications of a grammar. It is also easy to machine-generate codes for parsers constructed in accordance with the invention. Further, it is easy to switch between different domains. A parser in accordance with the present invention can even parse a program statement that includes commands or keywords from more than one domain. For example, an indicator of a domain may be interposed between two tokens of the program statement therefore signaling that the subsequent tokens should be processed using object(s) for the new indicated domain.

While many alternative implementations and optional features have been mentioned in the above description, other modifications will be apparent to those skilled in the art and, therefore, the invention is defined in the claims.

What is claimed is:

1. A computer readable medium containing computer executable instructions for parsing program statements which when executed by a processor, cause said processor to:
instantiate a root object having a list of all permissible initial tokens for a program statement; and
where an initial token in said program statement is represented in said list, instantiate a subsequent object having a list of all permissible subsequent tokens which may follow said initial token.

2. The computer readable medium of claim 1 wherein said processor is caused to instantiate a root object based on an indicator of a domain for said programming statement.

3. The computer readable medium of claim 1 or claim 2 wherein said root object includes a method to add a representation of said initial token to a parse data structure.

4. The computer readable medium of any of claim 1 to claim 3 wherein said subsequent object has a class associated with each permissible token in said list of all permissible subsequent tokens.

5. The computer readable medium of any of claim 2 to claim 4 further comprising a token data structure comprising a list of all possible tokens in each domain, each possible token statically associated with one unique identifier from a list of unique identifiers.

6. The computer readable medium of claim 5 further comprising a class data structure comprising said list of unique identifiers and a list of classes, each class associated with one unique identifier.

7. The computer readable medium of claim 6 wherein said subsequent object, when instantiated, changes at least one class associated with one unique identifier.

8. The computer readable medium of claim 1 wherein said processor is caused to:
where a token immediately subsequent to said initial token in said program statement is represented in said list of all permissible subsequent tokens, instantiate a further subsequent object having a list of all permissible subsequent tokens which may follow said token immediately subsequent to said initial token.

9. A parser, comprising:
means for instantiating a root object having a list of all permissible initial tokens for a program statement; and
means for, where an initial token in said program statement is represented in said list, instantiating a subsequent object having a list of all permissible subsequent tokens which may follow said initial token.

10. A method for parsing program statements, comprising:
instantiating a root object having a list of all permissible initial tokens for a program statement; and
where an initial token in said program statement is represented in said list, instantiating a subsequent object having a list of all permissible subsequent tokens which may follow said initial token.

11. A computing device having a processor and a memory for undertaking the method of claim 10.
